(19) United States
(12) Patent Application Publication
(10) Pub. No.: US 2015/0014604 A1
(43) Pub. Date: Jan. 15, 2015

(54) SILVER NANOWIRE BLENDED ELECTRICALLY CONDUCTIVE ELASTOMER COMPOSITION AND METHOD FOR MANUFACTURING THE SAME

(71) Applicant: National Taipei University of Technology, Taipei (TW)

(72) Inventor: SYANG-PENG RWEI, Taipei (TW)

(21) Appl. No.: 13/937,711

(22) Filed: Jul. 9, 2013

(51) Int. Cl. H01B 1/22

(52) U.S. Cl. CPC H01B 1/22
USPC 252/514

(57) ABSTRACT

The present invention provides a silver nanowire blended electrically conductive elastomer composition and method for manufacturing the same. The silver nanowire blended electrically conductive elastomer composition is formed by having a polyurethane prepolymer react with tetraaniline to form a copolymer, dissolving the copolymer in a solvent to form a copolymer solution and adding a doping agent and silver nanowires into the copolymer solution.

### BACKGROUND OF THE INVENTION

a. Field of the Invention

The invention relates to an electrically conductive elastomer composition and method for manufacturing the same, particularly to a silver nanowire blended electrically conductive elastomer composition and method for manufacturing the same.

b. Description of the Related Art

Generally, an electrically conductive elastomer is used as materials for electrical conducting, electromagnetic shielding, environmental sealing, etc., and is usually formed by coating a conductive layer on surfaces of an elastomer. For example, an electrically conductive elastomer is disclosed in WO 2000052710 but the conductive layer of the elastomer will be damaged or crack while the elastomer undergoes elongation because the conductive layer, such as a metallic layer, usually is not extendable.

Polyurethane (PU) elastomer is one of the commonly used elastomers and has electrical conductivity of 10⁻¹²˜10⁻¹⁰ S/cm, usually classified as an insulator. In order to increase electrical conductivity of a polyurethane elastomer, for example, according to TW 130042, poly(aniline-urethane) copolymer is disclosed and has electrical conductivity of about 10⁻⁷ S/cm while, according to TW 1300941, a conductive particle derived from a block copolymer is disclosed and has electrical conductivity of about 10⁻⁶ S/cm. The electrical conductivity of a polyurethane elastomer should be further increased in order to be used in various applications.

Furthermore, the inventor of the present invention discloses a tetraaniline containing conductive polyurethane having electrical conductivity of about 10⁻⁴ S/cm. The improvement in electrical conductivity is still necessary for broadening applications of PU elastomers. However, in the above prior arts, only the improvement of electrical conductivity is described but whether elongation of an elastomer can be maintained or not is not stated. Moreover, in principle the electrical conductivity of an elastomer can be increased by addition of conductive material(s) but the means not only to increase the electrical conductivity but also maintain the elongation of an elastomer (extendibility) is still required.

### BRIEF SUMMARY OF THE INVENTION

In light of the above background, in order to fulfill the requirements of the industry, one object of the invention provides a silver nanowire blended electrically conductive elastomer composition and method for manufacturing the same to form an electrically conductive elastomer having polyurethane as a matrix polymer. The resulting electrically conductive elastomer has good electrical conductivity with good characteristic of an elastomer (elongation property) and is suitable to various applications such as materials for electrical conducting, electromagnetic shielding, environmental sealing, etc.

Another object of the invention provides a silver nanowire blended electrically conductive elastomer, having at least 200% of elongation and more than 10⁻³ S/cm of electrical conductivity which is increased with increase of elongation of the elastomer. In addition, the elastomer is linear, thermoplastic and reworkable since the elastomer is formed with no crosslinking agent and no chain extending agent so as to have physical crosslinking only (such as through hydrogen bonding) and have a linear type thermoplastic elastomer which is reworkable. “Reworkable” means that the solid form of the elastomer can be heated and dissolved in a solvent to be reshaped.

Other objects and advantages of the invention can be better understood from the technical characteristics disclosed by the invention. In order to achieve one of the above purposes, all the purposes, or other purposes, one embodiment of the invention provides a silver nanowire blended electrically conductive elastomer composition. The silver nanowire blended electrically conductive elastomer composition comprises: a copolymer, formed by having a polyurethane prepolymer react with tetraaniline; a solvent wherein the copolymer is dissolved in the solvent to form a copolymer solution; a doping agent, added in the copolymer solution; and silver nanowires, blended into the copolymer solution.

In one embodiment, the tetraaniline and the polyurethane prepolymer with a molar ratio of 1:3 are used to react with each other to obtain the copolymer.

In one embodiment, the doping agent is a protonic acid to have the copolymer be charged. Preferably, the doping agent is dodecylbenzenesulfonic acid.

In one embodiment, the silver nanowires in the elastomer composition is 1˜3 wt % based on 100 wt % of total solid content in the elastomer composition.

In one embodiment, the polyurethane prepolymer is formed by having poly(tetramethyleneoxide) react with diphenylmethane diisocyanate and has an average molecular weight of 43000˜47000.

In one embodiment, the solvent is dimethyl formamide (DMF) and dimethyl sulfoxide (DMSO).

In one embodiment, the silver nanowires have an average wire diameter of 200˜600 nm and an average length of 20˜60 μm.

In one embodiment, a silver nanowire blended electrically conductive elastomer obtained by drying the silver nanowire blended electrically conductive elastomer composition has electrical conductivity more than 10⁻³ S/cm and its electrical conductivity increases with increase of elongation of the elastomer.

In one embodiment, the elastomer has at least 200% of elongation.

According to another embodiment of the invention, a silver nanowire blended electrically conductive elastomer is disclosed and the elastomer comprises: silver nanowires and a copolymer formed by reacting a polyurethane prepolymer with tetraaniline wherein the elastomer has at least 200% of elongation and electrical conductivity more than 10⁻³ S/cm and its electrical conductivity increases with increase of elongation of the elastomer. In one embodiment, the silver nanowire blended electrically conductive elastomer is of thin film.

Furthermore, according to one other embodiment of the invention, a method for manufacturing a silver nanowire blended electrically conductive elastomer composition is provided. The method comprises: providing a tetraaniline and a polyurethane prepolymer; having the tetraaniline react with polyurethane prepolymer to form a copolymer; dissolving the copolymer in a solvent to form a copolymer solution; and adding a doping agent and blending silver nanowires in the copolymer solution.

According to the silver nanowire blended electrically conductive elastomer composition and the method for manufacturing the same of the present invention, an electrically conductive elastomer having polyurethane as a matrix polymer can be formed. The resulting electrically conductive elastomer has good electrical conductivity with good characteristic of an elastomer (elongation property) and is suitable to various applications such as materials for electrical conducting, electromagnetic shielding, environmental sealing, etc. The electrically conductive elastomer has at least 200% of elongation and has good electrical conductivity reaching 10⁻² S/cm. Besides, the electrical conductivity of the elastomer according to the present invention has a characteristic of increasing with increase of elongation of the elastomer.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a method of synthesizing the copolymer according to one embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. The drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The common structures and elements that are known to everyone are not described in details to avoid unnecessary limits of the invention. Some preferred embodiments of the present invention will now be described in greater detail in the following.

According to one embodiment of the invention, a silver nanowire blended electrically conductive elastomer composition is provided. The silver nanowire blended electrically conductive elastomer composition comprises: a copolymer, formed by having a polyurethane prepolymer react with tetraaniline; a solvent where the copolymer is dissolved in the solvent to form a copolymer solution; a doping agent, added in the copolymer solution; and silver nanowires, blended into the copolymer solution. In the specification of the present invention, the so-called “nanowire” has one dimension (wire diameter) being nanometer scale and the other dimension (wire length) being, but not limited to, micrometer scale. Specifically, for example, silver nanowires have an average wire diameter of 200˜600 nm and an average wire length of 20˜60 μm. The conductivity of the electrically conductive elastomer formed by the silver nanowire blended electrically conductive elastomer composition is increased significantly because the wire length of the silver nanowire is long enough to bridge between the nonconductive urethane units, that is, the wire length of the silver nanowire is longer than that of the urethane unit in the copolymer.

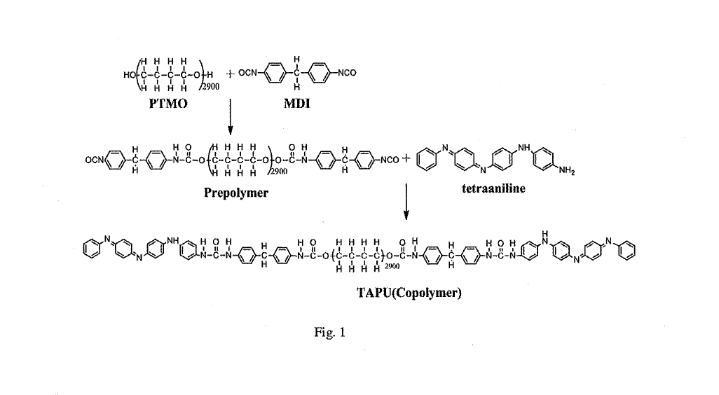

The method for synthesizing tetraaniline, for example, uses dianiline as an initiator to have oxidative polymerization under effect of ferric chloride so as to obtain tetraaniline. FIG. 1 shows a schematic diagram illustrating a method of synthesizing the copolymer according to one embodiment of the invention. The doping agent is a protonic acid to have the copolymer be charged. For example, the doping agent is organic acid, preferably dodecylbenzenesulfonic acid. Although the different ratio of tetraaniline to polyurethane prepolymer can be used, in order to have better conductivity, preferably the tetraaniline and the polyurethane prepolymer with a molar ratio of 1:3 are used to react with each other to obtain the copolymer.

Regarding the addition quantity of silver nanowires, when the elastomer composition has total solid content be 100 wt %, the silver nanowires in the elastomer composition is 1˜3 wt %. When the addition quantity of silver nanowires is too small to be insufficient, the effect of increasing electrical conductivity cannot be achieved. If the addition quantity of silver nanowires is too large, the effect of increasing electrical conductivity is limited and the cost is thereby increased to become undesirable economically. For example, the silver nanowires can have an average wire diameter of 200˜600 nm and an average length of 20˜60 μm.

The polyurethane prepolymer can be formed by having poly(tetramethyleneoxide) react with diphenylmethane diisocyanate and has an average molecular weight of 43,000˜47,000. The conductivity of the resulting copolymer will be decreased if the average molecular weight is too large while the characteristic of an elastomer will be insufficient if the average molecular weight is too small. Specifically, the increase of molecular weight of the soft segments (glycol monomer) can increase elongation of the copolymer so as to increase deformation rate and instantaneous recovery.

The solvent used in the composition is required to dissolve the resulting copolymer. For example, the solvent can be dimethyl formamide (DMF) and dimethyl sulfoxide (DMSO), preferably DMF.

The silver nanowire blended electrically conductive elastomer obtained by drying the silver nanowire blended electrically conductive elastomer composition has electrical conductivity more than 10⁻³ S/cm and its electrical conductivity increases with increase of elongation of the elastomer. In addition, the elastomer has at least 200% of elongation.

The silver nanowire blended electrically conductive elastomer can be obtained by using the above silver nanowire blended electrically conductive elastomer composition and the elastomer comprises silver nanowires and a copolymer formed by reacting a polyurethane prepolymer with tetraaniline wherein the elastomer has at least 200% of elongation and electrical conductivity more than 10⁻³ S/cm and its electrical conductivity increases with increase of elongation of the elastomer. Furthermore, the silver nanowire blended electrically conductive elastomer can be shaped into a thin film, a ring or any other shape according to applications. In addition, the elastomer is linear, thermoplastic and reworkable since the elastomer is formed with no crosslinking agent and no chain extending agent so as to have physical crosslinking only (such as through hydrogen bonding) and have a linear type thermoplastic elastomer which is reworkable. “Reworkable” means that the solid form of the elastomer can be heated and dissolved in a solvent to be reshaped. Usually, the reheating process to melt the elastomer is about 65˜70° C. The solvent used to dissolve the elastomer can be any solvent as long as the solvent can dissolve the elastomer.

Furthermore, according to one other embodiment of the invention, a method for manufacturing a silver nanowire blended electrically conductive elastomer composition is provided. The method comprises: providing a tetraaniline and a polyurethane prepolymer; having the tetraaniline react with polyurethane prepolymer to form a copolymer; dissolving the copolymer in a solvent to form a copolymer solution; and adding a doping agent and blending silver nanowires in the copolymer solution. The following will use examples to further illustrate the present invention.

### Example

### (1) Synthesizing Tetraaniline

10 g of N-phenyl-p-phenylene-diamine was used and placed in a mill to be crashed into powders and then the powders and 700 ml of 0.1M HCl solution were added together into a 1L flask. The solution was stirred for 12 hrs (500 rpm) by a high speed stirrer so as to have the dianiline completely dissolved in the HCl solution. After suction filtration, the undissolved dianiline was removed. Then, the clear solution was used and added with 7 g of dried ferric chloride (FeCl₃) to have oxidative polymerization at room temperature. After stirring for 12 hrs, precipitations were filtered with suction and then again 700 ml of 0.1M HCl solution was added. The reaction solution was stirred for 12 hrs. The above process of adding HCl (700 ml of 0.1M HCl solution), stirring (for 12 hrs) and filtering is repeated for three times and then the solution became viscous and also became bright green color from dark green. The viscous solution was then processed under suction filtration and the precipitations were taken and added with 0.1M ammonia water to be stirred for 12 hrs for neutralization. Finally, distilled water was used to remove ammonia and the precipitations were dried for 2 days in a vacuum oven at 65° C. Tetraaniline (C₂₄N₄H₂₂) was obtained and has MW about 366 (by a MASS analyzer, 365˜368 m/z).

### (2) Synthesizing Polyurethane Prepolymer

PTMO (Poly(tetramethyleneoxide), MW=2900) and MDI (4,4′-Diphenylmethane diisocyanate, MW=250) with a molar ratio of 1:2 were placed in a four-necked reaction flask and reacted at 65° C. for 4 hrs under nitrogen environment so as to obtain a transparent colorless polyurethane prepolymer. The polyurethane prepolymer was tested by FTIR where for IR spectra NCO group is positioned at 2270 cm⁻¹ and —NH group is positioned at 3300 cm⁻¹. The absorption peaks for NCO group and —NH group were observed. Thus, the polyurethane (PU) prepolymer was identified.

### (3) Preparing Tetraaniline-Polyurethane-Silver Nanowire Copolymer

The above PU prepolymer was added into a DMF solution containing tetraaniline to have a molar ratio of tetraaniline to polyurethane prepolymer be 1:3 and have reaction for 3 hrs at 65° C. under nitrogen environment. The resulting product was then poured into a PTFE mold and placed in an oven at 70° C. for 2 days so as to obtain a black-violet colored copolymer film. The IR spectrum of the tetraaniline-polyurethane copolymer shows the characteristic peaks of —NH—CO—NH—(called “urea group”) structure at 1720 cm⁻¹ and 1670 cm⁻¹ because —NCO group of the PU prepolymer reacts with —NH2 group of tetraaniline and the absorption peak of —NCO group disappeared after reaction. Thus, it was confirmed that the tetraaniline-polyurethane copolymer was obtained.

Then, 0.5 g of the tetraaniline-polyurethane copolymer was used and dissolved in DMF and then different amount of silver nanowires or graphene was added (1 wt %, 2 wt %, 3 wt %). Six sets (copolymer 1˜6 with different ratios of silver nanowires and graphene) were obtained. Finally, 3 ml of DBSA (dodecylbenzenesulfonic acid) as a doping agent was added into each set and DMF was used as the solvent. The mixture solution was heated to 700° C. and stirred for 2 hrs and placed under supersonic oscillation for 30 mins. The solution was poured into a plate and dried in an oven for 2 days. Then, the electrically conductive composite thin film I˜VI were obtained. The characteristics of electrically conductive composite thin film I˜VI were shown in Table I.

TABLE I
characteristics of electrically conductive composite thin film I~VI

| | | | Permanent | |
|---|---|---|---|---|
| composite | | Maximum | deformation | Recovery |
| thin film | Formula* | elongation (%) | rate (%) | rate (%) |
| I | TAPU-1% Ag | 81.55% | 16.26% | 80.01% |
| II | TAPU-2% Ag | 38.74% | 8.51% | 78.03% |
| III | TAPU-3% Ag | 18.97% | 4.97% | 73.80% |
| IV | TAPU-1% G | 51.17% | 9.69% | 81.63% |
| V | TAPU-2% G | 23.49% | 5.68% | 75.82% |
| VI | TAPU-3% G | 16.19% | 4.66% | 71.22% |

*TAPU-w % Ag: w % of silver nanowires blended in tetraaniline-polyurethane copolymer; TAPU-w % G: w % of graphene blended in tetraaniline-polyurethane copolymer

The characteristics of electrically conductive composite thin film I˜VI before and after elongation were shown in Table II where 0% elongation means before elongation. The data in Table I are obtained by a dynamic mechanical analyzer (DMA-7e by Perkin-Elmer) under the creep/recovery mode where the cross-sectional area of the tested film is 0.927 mm2, the fixed stress is 323.7 kPa, and the fixed force is 300 mN for 30 mins (creep) and 30 mN for 30 mins (recovery).

TABLE II
characteristics of electrically conductive composite thin film I~VI
before and after elongation

| | | film No. | | | | | |
|---|---|---|---|---|---|---|---|
| | | I | II | III | IV | V | VI |
| | Elongation | Conductivity | | | | | |
| | (%) | (S/cm) | | | | | |
| 1^{st} | 0 | 3.48E−3 | 6.49E−3 | 3.60E−2 | 1.12E−3 | 6.05E−3 | 1.21E−2 |
| time | 50 | 4.52E−3 | 9.54E−3 | 4.01E−2 | 3.70E−3 | 8.10E−3 | 1.60E−2 |
| | 100 | 6.47E−3 | 1.45E−2 | 4.53E−2 | 6.25E−3 | 9.93E−3 | 2.20E−2 |
| | 150 | 8.56E−3 | 1.96E−2 | 5.22E−2 | 8.63E−3 | 1.34E−2 | 2.80E−2 |
| | 200 | 1.09E−2 | 2.54E−2 | 5.86E−2 | 1.22E−2 | 1.80E−2 | Unable |
| 2^{nd} | 0 | 3.48E−3 | 6.49E−3 | 3.60E−2 | 1.12E−3 | 6.05E−3 | 1.21E−2 |
| time | 200 | 1.12E−2 | 2.62E−2 | 5.90E−2 | 1.25E−2 | 2.10E−2 | ^{}3.01E−2 |

^{}this number is the conductivity at 150% of elongation because film 6 cannot have 200% of elongation.

In table II, “Film No. I˜VI” represents electrically conductive composite thin film I˜VI. A parallel type tensile tester was used to extend the film and its conductivity was tested. It was found that when the film is extended to 50% elongation, the conductivity has a trend of increasing. After the film is repeatedly extended for three times, the conductivity at 0% and 200% of elongation is slightly higher than the previous time. It may be due to the orientation of the conjugated polymer chain. After extension, electron jump is easier and then the conductivity is increased. The increase of the conductivity becomes more obvious for 200% of elongation. The film forming characteristic of film 6 is not good and thus the maximum elongation is 150% where the conductivity is also increased with increase of elongation.

Furthermore, the electrically conductive elastomers (TAPU, TAPU-1% Ag, TAPU-2% Ag, TAPU-3% Ag, TAPU-1% G, TAPU-2% G, and TAPU-3% G) are formed into a test sample plate (size 2×4 cm; 0.3 mm thickness) and tested by a MTS (Testing systems, mechanical testing and sensing solutions) tester at a pulling speed of 10 mm/min where “TAPU” means tetraaniline-polyurethane copolymer. The data are shown in Table III as average values from three measurements for each sample plate.

TABLE III
MTS test for elastomers

| | Tensile | | Young's |
|---|---|---|---|
| | strength | Elongation | Modulus |
| Sample | (MPa) | (%) | (MPa) |
| TAPU | 2.79 | 1033 | 0.026 |
| TAPU-1% Ag | 2.98 | 682 | 0.080 |
| TAPU-2% Ag | 5.38 | 512 | 0.559 |
| TAPU-3% Ag | 5.70 | 387 | 1.542 |
| TAPU-1% G | 5.21 | 553 | 0.193 |
| TAPU-2% G | 5.59 | 433 | 1.083 |
| TAPU-3% G | 6.50 | 154 | 2.431 |

The result shows that pristine TAPU has the highest elongation rate, silver-nanowire blended TAPU has the slightly lower, and graphene blended TAPU has the lowest. Graphene has more impact on mechanical properties than silver nanowire.

The comparison films using graphene instead of silver nanowires are formed and tested to show that other conductive materials may be added into the copolymer to increase the conductivity but elongation property of the elastomer is affected. Variation of the glass transition temperature (Tg) is larger if graphene is blended in the copolymer while variation of the glass transition temperature (Tg) is smaller if silver nanowires are blended in the copolymer. It shows that graphene as a conductive nanomaterial will influence the property of the copolymer to worsen the mechanical property of the composite material.

In conclusion, according to the silver nanowire blended electrically conductive elastomer composition and the method for manufacturing the same of the present invention, an electrically conductive elastomer having polyurethane as a matrix polymer can be formed. The resulting electrically conductive elastomer has good electrical conductivity with good characteristic of an elastomer (elongation property) and is suitable to various applications such as materials for electrical conducting, electromagnetic shielding, environmental sealing, etc. The electrically conductive elastomer has at least 200% of elongation and has good electrical conductivity reaching 10⁻² S/cm. Besides, the electrical conductivity of the elastomer according to the present invention has a characteristic of increasing with increase of elongation of the elastomer.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A silver nanowire blended electrically conductive elastomer composition, comprising:
a copolymer, formed by having a polyurethane prepolymer react with tetraaniline;
a solvent, wherein the copolymer is dissolved in the solvent to form a copolymer solution;
a doping agent, added in the copolymer solution; and
silver nanowires, blended into the copolymer solution to distribute uniformly so as to form a silver nanowire blended electrically conductive elastomer composition.

2. The silver nanowire blended electrically conductive elastomer composition as claimed in claim 1, wherein the tetraaniline and the polyurethane prepolymer with a molar ratio of 1:3 are used to react with each other to obtain the copolymer.

3. The silver nanowire blended electrically conductive elastomer composition as claimed in claim 1, wherein the doping agent is a protonic acid.

4. The silver nanowire blended electrically conductive elastomer composition as claimed in claim 1, wherein the doping agent is dodecylbenzenesulfonic acid.

5. The silver nanowire blended electrically conductive elastomer composition as claimed in claim 1, wherein the silver nanowires in the elastomer composition is 1˜3 wt % based on 100 wt % of total solid content in the elastomer composition.

6. The silver nanowire blended electrically conductive elastomer composition as claimed in claim 1, wherein the polyurethane prepolymer is formed by having poly(tetramethyleneoxide) react with diphenylmethane diisocyanate and has an average molecular weight of 43,000˜47,000.

7. The silver nanowire blended electrically conductive elastomer composition as claimed in claim 1, wherein the solvent is dimethyl formamide (DMF) or dimethyl sulfoxide (DMSO).

8. The silver nanowire blended electrically conductive elastomer composition as claimed in claim 1, wherein the silver nanowires have an average wire diameter of 200˜600 nm and an average length of 20˜60 μm.

9. The silver nanowire blended electrically conductive elastomer composition as claimed in claim 1, wherein a silver nanowire blended electrically conductive elastomer obtained by drying the silver nanowire blended electrically conductive elastomer composition has electrical conductivity more than 10⁻³ S/cm and its electrical conductivity increases with increase of elongation of the elastomer.

10. The silver nanowire blended electrically conductive elastomer composition as claimed in claim 9, wherein the elastomer has at least 200% of elongation.

11. The silver nanowire blended electrically conductive elastomer composition as claimed in claim 9, wherein the elastomer is linear, thermoplastic and reworkable.

12. A silver nanowire blended electrically conductive elastomer, comprising:
silver nanowires and a copolymer formed by reacting a polyurethane prepolymer with tetraaniline wherein the elastomer has at least 200% of elongation and electrical conductivity more than 10⁻³ S/cm and its electrical conductivity increases with increase of elongation of the elastomer.

13. The silver nanowire blended electrically conductive elastomer as claimed in claim 12, wherein the copolymer is formed by using tetraaniline and the polyurethane prepolymer with a molar ratio of 1:3 to react with each other.

14. The silver nanowire blended electrically conductive elastomer as claimed in claim 12, comprising 1˜3 wt % of silver nanowires.

15. The silver nanowire blended electrically conductive elastomer as claimed in claim 12, wherein the polyurethane prepolymer is formed by having poly(tetramethyleneoxide) react with diphenylmethane diisocyanate and has an average molecular weight of 43,000˜47,000.

16. The silver nanowire blended electrically conductive elastomer as claimed in claim 12, wherein the silver nanowires have an average wire diameter of 200˜600 nm and an average length of 20˜60 μm.

17. The silver nanowire blended electrically conductive elastomer as claimed in claim 12, being of thin film.

18. A method for manufacturing a silver nanowire blended electrically conductive elastomer composition, comprising:
providing a tetraaniline and a polyurethane prepolymer;
having the tetraaniline react with polyurethane prepolymer to form a copolymer;
dissolving the copolymer in a solvent to form a copolymer solution; and
adding a doping agent and blending silver nanowires in the copolymer solution.

19. The method as claimed in claim 18, wherein the tetraaniline and the polyurethane prepolymer with a molar ratio of 1:3 are used to react with each other to obtain the copolymer.

20. The method as claimed in claim 18, wherein the doping agent is a protonic acid and the silver nanowires have an average wire diameter of 200˜600 nm and an average length of 20˜60 μm.

21. The method as claimed in claim 18, wherein the polyurethane prepolymer is formed by having poly(tetramethyleneoxide) react with diphenylmethane diisocyanate and has an average molecular weight of 43,000˜47,000.
